(19) United States
(12) Patent Application Publication
(10) Pub. No.: US 2004/0166781 A1
(43) Pub. Date: Aug. 26, 2004

(54) Composition for texturing process

(76) Inventor: Jiro Yamada, Shiojiri-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/472,818

(22) PCT Filed: Mar. 27, 2002
(86) PCT No.: PCT/JP02/02988

(30) Foreign Application Priority Data
Mar. 27, 2001 (JP) 2001-089030

(51) Int. Cl. C09K 3/14; B24B 1/00

(52) U.S. Cl. 451/41; 65/61; 65/30.14; 51/307; 51/308; 51/309

(57) ABSTRACT

A composition contains abrasive grains, solvent and a fluoride and can be used for accurately texturing a magnetic disk glass substrate. The magnetic disk glass substrate is produced using a method that includes the steps of pressing the surface of a magnetic disk glass substrate against the surface of an object for sliding contact at a pressure falling within a range of 0.98 to 196 N, feeding the composition onto at least one of the surface of the object and the surface of the magnetic disk glass substrate, and rotating the magnetic disk glass substrate while the object remains pressed, to thereby perform texturing of the surface of the magnetic disk glass substrate.

### CROSS REFERENCE TO RELATED APPLICATIONS

This application is an application filed under 35 U.S.C. § 111(a) claiming the benefit pursuant to 35 U.S.C. § 119(e) (1) of the filing date of Provisional Application No. 60/280,758 filed Apr. 3, 2001 pursuant to 35 U.S.C. §111(b).

### TECHNICAL FIELD

The present invention relates to a composition for use in texturing a magnetic disk glass substrate.

### BACKGROUND ART

In order to meet recent demand for increasing the recording density of magnetic disks, the distance between the magnetic disk surface and the magnetic head has been progressively reduced, for example, to approximately 50 to 100 nm. Thus, the magnetic disk surface must be as flat as possible. Such a high degree of flatness of the magnetic disk surface raises a problem. That is, when a magnetic head is stuck onto a magnetic disk, the hard disk drive cannot be started. In order to eliminate this problem, magnetic disk substrates have been subjected to texturing so as to form lines on the surfaces of the substrates.

Recently, studies have revealed that, when a magnetic layer is formed on a substrate having minute texture lines on its surface, magnetic properties and electromagnetic conversion characteristics are improved as compared with the case of a magnetic layer formed on a substrate having no texturing line on its surface. Thus, texturing is an essential process for producing a hard disk of high recording density.

Texturing is a process in which a magnetic disk substrate is scrubbed through sliding contact with an abrasive tape to which abrasive grains having a specific particle size adhere or with a suspension of abrasive grains by use of a support such as a tape, to thereby form minute lines on the surface of the magnetic disk substrate. Conventionally, as a composition for use in texturing for forming such texture lines, there has been employed a slurry prepared by mixing abrasive grains formed of diamond or alumina with a polishing liquid.

NiP-plated aluminum substrates (i.e., aluminum substrates) have typically been employed as magnetic disk substrates. However, in recent years, magnetic disk glass substrates have come to be employed by virtue of their properties including lightweight and high rigidity. Accordingly, texturing is desired more and more for magnetic disk glass substrates in order to improve magnetic properties and electromagnetic conversion characteristics by reducing the distance between the substrate surface and the magnetic head, thereby attaining high recording density.

However, it is very difficult to form on a magnetic disk glass substrate such minute texture lines as those provided on an aluminum substrate since the magnetic disk glass substrate has the characteristics of high rigidity and hardness.

An object of the present invention is to provide a composition that allows texturing of a magnetic disk glass substrate, a slurry for use in the texturing, a method for producing a magnetic disk glass substrate that has been subjected to texturing and a magnetic disk glass substrate produced by the method.

### DISCLOSURE OF THE INVENTION

The present invention provides a composition for use in texturing a magnetic disk glass substrate, which comprises abrasive grains, solvent and a fluoride.

The fluoride is at least one species selected from the group consisting of ammonium fluoride, potassium fluoride and sodium fluoride.

The composition contains the fluoride in an amount falling within the range of 0.01 to 10 mass % based on the total amount of the composition and has a fluorine ion concentration falling within the range of 0.003 to 3 mol/kg.

The composition contains the abrasive grains in an amount falling within the range of 0.001 to 5 mass % based on the total amount of the composition, and the abrasive grains are grains of at least one species selected from the group consisting of diamond, CBN, alumina, and silicon carbide and have the maximum particle size of 5 μm or less and the average particle size falling within the range of 0.01 to 1 μm.

The solvent contains a substance that can dissolve the fluoride, and the substance is water.

The solvent is at least one species selected from the group consisting of alkylene glycol monoalkyl ethers represented by formula R₁O(CₙH₂ₙO)ₘH (wherein R₁ represents a C1-C4 linear or branched alkyl group, m is an integer of 1, 2 or 3, and n is an integer of 2 or 3), derivatives thereof, C2-C5 polyhydric alcohols and derivatives thereof.

The composition contains the solvent in an amount falling within the range of 1 to 50 mass % based on the total amount of the composition.

The present invention also provides a slurry for use in texturing, which comprises the composition and may further comprise at least one additional species selected from the group consisting of water, C1-C10 monohydric alcohols, glycols, C3-C10 polyhydric alcohols, dimethyl sulfoxide, dimethylformamide, tetrahydrofuran and dioxane.

The slurry contains the composition in an amount falling within the range of 10 to 80 mass % based on the total amount of the slurry.

The present invention also provides a method for producing a magnetic disk glass substrate that has undergone texturing, which comprises pressing the surface of a magnetic disk glass substrate against the surface of an object for sliding contact at a pressure falling within a range of 0.98 to 196 N; feeding the composition or slurry onto at least one of the surface of the object and the surface of the magnetic disk glass substrate; and rotating the magnetic disk glass substrate while the object remains pressed, to thereby perform texturing of the surface of the magnetic disk glass substrate.

In the method, the object is formed of any one of materials selected from the group consisting of woven fabric, non-woven fabric and flocked fabric each made of nylon fiber or polyester fiber, and polyurethane foam.

In the method, the magnetic disk glass substrate is rotated at a rate falling within a range of 50 to 2,000 rpm.

In the method, the magnetic disk glass substrate has a surface that is NiP-plating-free prior to texturing, and is formed of unstrengthened glass, chemically strengthened glass or glass ceramic.

The present invention also provides a magnetic disk glass substrate that is produced through the method just mentioned above or through texturing using the aforementioned composition or slurry.

### BRIEF DESCRIPTION OF THE DRAWINGS

FIG. 1(a) is schematic front view showing the state in which a magnetic disk substrate is subjected to texturing according to the present invention.

FIG. 1(b) is a perspective view showing the state of FIG. 1.

### BEST MODE FOR CARRYING OUT THE INVENTION

The present invention is directed to a composition for use in texturing a magnetic disk glass substrate that contains abrasive grains and solvent, and is characterized by further containing a fluoride.

During the course of texturing, the fluoride contained in the composition of the present invention for use in texturing a magnetic disk glass substrate softens the surface of the magnetic disk glass substrate by its chemical action, to thereby facilitate exertion of mechanical action of the abrasive grains onto and formation of texturing lines by the abrasive grains on the surface of the magnetic disk glass substrate.

The species of fluorides used in the present invention varies in accordance with the type of solvent and abrasives employed. Examples thereof include allyl fluoride, aluminum fluoride, antimony fluoride, ammonium fluoride, sulfur fluoride, uranyl fluoride, ethyl fluoride, cadmium fluoride, potassium fluoride, gallium fluoride, calcium fluoride, silver fluoride, chromyl fluoride, germanium fluoride, cobalt fluoride, oxygen fluoride, hydrogen fluoride, ammonium hydrogen fluoride, potassium hydrogen fluoride, silver hydrogen fluoride, cobalt hydrogen fluoride, sodium hydrogen fluoride, rubidium hydrogen fluoride, tin fluoride, strontium fluoride, cesium fluoride, thallium fluoride, tantalum fluoride, titanium fluoride, iron fluoride, copper fluoride, sodium fluoride, lead fluoride, nickel fluoride, nitrile fluoride, barium fluoride, beryllium fluoride, magnesium fluoride, manganese fluoride, molybdenum fluoride, lithium fluoride, ruthenium fluoride, rubidium fluoride, zinc hexafluorosilicate, ammonium hexafluorosilicate, cadmium hexafluorosilicate, calcium hexafluorosilicate, cobalt hexafluorosilicate, mercury hexafluorosilicate, strontium hexafluorosilicate, thallium hexafluorosilicate, iron hexafluorosilicate, copper hexafluorosilicate, sodium hexafluorosilicate, lead hexafluorosilicate, nickel hexafluorosilicate, barium hexafluorosilicate, magnesium hexafluorosilicate, lithium hexafluorosilicate, rubidium hexafluorosilicate, ammonium tetrafluoroberyllate, potassium tetrafluoroberyllate, sodium tetrafluoroberyllate, ammonium tetrafluoroborate, potassium tetrafluoroborate, sodium tetrafluoroborate, ammonium fluoromolybdate, potassium fluoromolybdate, thallium fluoromolybdate, sodium fluoromolybdate, ammonium fluorosulfate, potassium fluorosulfate, sodium fluorosulfate, lithium fluorosulfate, ammonium fluorophosphate, potassium fluorophosphate and sodium fluorophosphate. Among these fluorides, examples of preferable fluorides include aluminum fluoride, antimony fluoride, ammonium fluoride, sulfur fluoride, uranyl fluoride, cadmium fluoride, potassium fluoride, chromyl fluoride, silver fluoride, germanium fluoride, cobalt fluoride, hydrogen fluoride, ammonium hydrogen fluoride, potassium hydrogen fluoride, silver hydrogen fluoride, cobalt hydrogen fluoride, sodium hydrogen fluoride, rubidium hydrogen fluoride, tin fluoride, cesium fluoride, thallium fluoride, tantalum fluoride, titanium fluoride, copper fluoride, sodium fluoride, nitrile fluoride, barium fluoride, beryllium fluoride, manganese fluoride, molybdenum fluoride, lithium fluoride, ruthenium fluoride, rubidium fluoride, zinc hexafluorosilicate, ammonium hexafluorosilicate, cadmium hexafluorosilicate, cobalt hexafluorosilicate, mercury hexafluorosilicate, strontium hexafluorosilicate, thallium hexafluorosilicate, iron hexafluorosilicate, copper hexafluorosilicate, sodium hexafluorosilicate, lead hexafluorosilicate, nickel hexafluorosilicate, magnesium hexafluorosilicate, lithium hexafluorosilicate, ammonium tetrafluoroberyllate, potassium tetrafluoroberyllate, sodium tetrafluoroberyllate, ammonium tetrafluoroborate, sodium tetrafluoroborate, ammonium fluoromolybdate, potassium fluoromolybdate, sodium fluoromolybdate, ammonium fluorosulfate, potassium fluorosulfate, sodium fluorosulfate, lithium fluorosulfate, ammonium fluorophosphate, potassium fluorophosphate and sodium fluorophosphate. Among these preferable fluorides, examples of more preferable fluorides include ammonium fluoride, sulfur fluoride, potassium fluoride, chromyl fluoride, hydrogen fluoride, ammonium hydrogen fluoride, potassium hydrogen fluoride, sodium hydrogen fluoride, sodium fluoride and ammonium tetrafluoroborate. Among these more preferable fluorides, examples of most preferable fluorides include ammonium fluoride, potassium fluoride and sodium fluoride.

In order to form favorable texture lines on the surface of a magnetic disk glass substrate, using abrasive grains, it is preferable that the fluoride used in the present invention be homogeneously dispersed in the composition for use in texturing a magnetic disk glass substrate. Homogeneous dispersion of the fluoride in the composition is obtained by mechanically stirring the composition containing the fluoride or subjecting the composition to ultrasonic vibration or the like. Preferably, a substance that can dissolve the fluoride is incorporated into the solvent contained in the composition, thereby homogeneously dissolving or dispersing the fluoride in the composition.

Examples of substances that can dissolve the fluorides include water; C1-C10 monohydric alcohols, such as methanol, ethanol, propanol, isopropanol and butanol; acetone; ethers; hydrochloric acid; sulfuric acid; nitric acid; and acetic acid. Water is particularly preferable.

Examples of the solvents used in the present invention include C1-C10 monohydric alcohols, such as methanol, ethanol, propanol, isopropanol and butanol; dimethyl sulfoxide (DMSO), dimethylformamide (DMF); tetrahydrofuran; dioxane; and derivatives thereof. Particularly, alkylene glycol monoalkyl ethers represented by formula R₁O(CₙH₂ₙO)ₘH (wherein R₁ represents a C1-C4 linear or branched alkyl group, m is an integer of 1, 2 or 3, and n is an integer of 2 or 3), their derivatives, C2-C5 polyhydric alcohols or their derivatives are preferably used. Water is most preferable.

No particular limitation is imposed on the alkylene glycol monoalkyl ethers and derivatives thereof, but specific examples include ethylene glycol monomethyl ether (CH₃OCH₂CH₂OH), ethylene glycol monoethyl ether (C₂HsOCH₂cH₂OH), ethylene glycol monobutyl ether (C₄H₉OCH₂CH₂OH), diethylene glycol monomethyl ether (CH₃(OCH₂CH₂)₂OH), diethylene glycol monoethyl ether (C₂H₅(OCH₂CH₂)₂OH), diethylene glycol monobutyl ether (C₄H₉(OCH₂CH₂)₂OH) propylene glycol monomethyl ether (CH₃OCH (CH₃) CH₂OH), propylene glycol monoethyl ether (C₂H₅OCH (CH₃) CH₂OH), propylene glycol monobutyl ether (C₄H₉OCH (CH₃) CH₂OH) dipropylene glycol monomethyl ether (CH₃(OCH(CH₃) CH₂)₂OH), dipropylene glycol monoethyl ether (C₂H₅(OCH(CH₃)CH₂)₂OH), triethylene glycol monomethyl ether (CH₃(0CH₂CH₂)₃OH), triethylene glycol monoethyl ether (C₂H₅(OCH₂CH₂)₃OH) and tripropylene glycol monomethyl ether (CH₃(0CH₂CH₂CH₂)₃OH).

No particular limitation is imposed on the C2-C5 polyhydric alcohols and derivatives thereof, but specific examples include ethylene glycol (HOCH₂CH₂OH), propylene glycol (CH₃CH(OH)CH₂OH), 1,3-propanediol (HO(CH₂)₃OH), 1,2-butanediol (HOCH₂CH (OH) CH₂CH₃), 1,3-butanediol (HOCH₂CH₂CH(OH)CH₃), 1,4-butanediol (HO(CH₂)₄OH), 2,3-butanediol (CH₃CH(OH)CH(OH)CH₃), 1,2-pentanediol (HOCH₂CH (OH) CH₂CH₂CH₃), 1, 3-pentanediol (HOCH₂CH₂CH (OH) CH₂CH₃), 1,4-pentanediol (HOCH₂CH₂CH₂CH (OH) CH₃), 1,5-pentanediol (HO(CH₂)₅OH), 2,3-pentanediol (CH₃CH(OH)CH(OH)CH₂CH₃), 2,4-pentanediol (CH₃CH(OH)CH₂CH(OH)CH₃), 2-methyl-1,2-propanediol (HOCH₂C (CH₃) (OH) CH₃), 2-methyl-1,3-propanediol (HOCH₂CH (CH₃) CH₂OH), 2-methyl-1,2-butanediol (HOCH₂C (CH₃) (OH) CH₂CH₃), 2-methyl-1,3-butanediol (HOCH₂CH (CH₃)CH (OH) CH₃), 2-methyl-1,4-butanediol (HOCH₂CH (CH₃) CH₂CH₂OH), 2-methyl-2,3-butanediol (CH₃C(CH₃)OH)CH(OH)CH₃), 2-methyl-2,4-butanediol (CH₃C (CH₃) (OH) CH₃CH₂OH), 2-methyl-3,4-butanediol (CH₃CH (CH₃) CH (OH) CH₂OH), diethylene glycol (HOCH₂CH₂OCH₂CH₂OH), triethylene glycol (HOCH₂CH₂OCH₂CH₂OCH₂CH₂OH), polyethylene glycol (HO (CH₂CH₂O) (CH₂CH₂OH), dipropylene glycol (HOCH(CH₃)CH₂OCH₂CH(CH₃)OH), tripropylene glycol (HOCH (CH₃) CH₂OCH₂CH (CH₃) OCH₂CH (CH₃) OH), polypropylene glycol (HOCH (CH₃) CH₂O (CH₂CH (CH₃) 0) (CH₂CH (CH₃) OH) and glycerin (HOCH₂CH(OH)CH₂OH). These alcohols may be used singly or in combination of two or more species. In the aforementioned formulae, representing polyethylene glycol and polypropylene glycol, the suffix “q” represents an integer of 4 or more.

The concentration of the fluoride of the present invention preferably falls within a range of 0.01 to 10 mass % based on the total amount of the composition for use in texturing. When the concentration of the fluoride is less than 0.01 mass %, sufficient softening of the surface of a magnetic disk glass substrate is difficult to attain, leading to difficulty in the formation of clear texture lines. Even though the concentration is elevated to more than 10 mass %, further enhancement in the number and figure of texture lines is not recognizable.

The concentration of the fluorine ions contained in the composition of the present invention for use in texturing preferably falls within a range of 0.003 to 3 mol/kg, with respect to the composition for use in texturing. When the fluorine ion concentration is less than 0.003 mol/kg, sufficient softening of the surface of a magnetic disk glass substrate is difficult to attain, leading to difficulty in the formation of clear texture lines. Even though the concentration is elevated to more than 3 mol/kg, further enhancement in the number and figure of texture lines is not recognizable.

Regarding the abrasive grains used in the present invention, abrasives typically used as polishing agents that include diamond, CBN, alumina, silicon carbide, zirconia and titania, can be used. Of these, diamond, CBN, alumina and silicon carbide are particularly preferably used. These abrasives, having high hardness, can attain favorable texturing performance.

The diamond used in the present invention as abrasive grains is diamond which occurs naturally or is industrially synthesized and which has a particle size corresponding to that of coarse powder or micropowder of abrasive or abrasive grains prescribed in accordance with JIS R6001-1987. However, other than these particles, there may also be used particles exhibiting a particular particle size distribution in which the maximum particle size is 10 μm or less.

The CBN used in the present invention as abrasive grains is industrially synthesized CBN that has the aforementioned particle size prescribed in accordance with JIS R6001-1987. However, other than these particles, there may be also used microparticles or powder exhibiting a particular particle size distribution in which the maximum particle size is 10 μm or less.

The alumina or silicon carbide used in the present invention as abrasive grains is an artificial abrasive prescribed in accordance with JIS R6111-1987 or a similar material, and is powder which has a particle size corresponding to that of coarse powder or micropowder of abrasive or abrasive grains prescribed in accordance with JIS R6001-1987. In addition, alumina powder and silicon carbide powder for sintering are also included within the scope of the present invention.

Preferably, the aforementioned abrasive grains have a maximum particle size of 5 μm or less, more preferably 3 μm or less. When the maximum particle size is in excess of 5 μm, the texture lines to be formed tend to have an excessive width, leading to difficulty in the formation of minute texture lines.

The aforementioned abrasive grains have an average particle size of 0.01 to 1 μm, preferably 0.03 to 0.5 μm. When the average particle size exceeds 1 μm, the texture lines to be formed tend to have an excessive width, leading to difficulty in the formation of minute texture lines, whereas when the size is less than 0.01 μm, polishing performance is deteriorated, leading to difficulty in the formation of clear lines on the surface of a magnetic disk glass substrate.

The abrasive grains of the present invention are preferably contained in the composition for use in texturing, in an amount falling within the range of 0.001 to 5 mass %, more preferably 0.005 to 1 mass %, based on the total amount of the composition. When the amount of the abrasive grains is less than 0.001 mass %, the number of micrograms serving as abrasive grains decreases, leading to difficulty in the formation of clear lines on the surface of a magnetic disk glass substrate. When the amount of the abrasive grains is elevated to more than 5 mass %, further enhancement in the number and figure of lines to be formed is not recognizable, and thus amounts exceeding 5 mass % are proven to be economically disadvantageous.

In the present invention, two or more species of abrasive grains may be used in combination. In this case, the total amount of the abrasive grains preferably falls within the aforementioned range.

In the present invention, the solvent content preferably falls within the range of 1 to 50 mass %, more preferably 3 to 30 mass %, based on the total amount of the composition for use in texturing.

When the solvent content is less than 1 mass %, the composition has poor viscosity, leading to difficulty in the formation of uniform texture lines, whereas when the content exceeds 50 mass %, the viscosity of the composition is excessively high, leading to difficulty in the formation of minute texture lines.

By use of the composition of the present invention for use in texturing a magnetic disk glass substrate, uniform and minute texture lines can be formed on the surface of a magnetic disk glass substrate.

The composition of the present invention for use in texturing a magnetic disk glass substrate may be mixed with another solvent for appropriately adjusting the concentration, to thereby provide a slurry. No particular limitation is imposed on the method for producing the slurry, but the slurry can be produced by appropriately adapting a dry-milling process, a wet-milling process, or other processes.

Examples of dry-milling processes include vibration milling and jet milling, and examples of wet-milling processes include ball milling and bead milling.

In order to adjust the concentration of the composition of the present invention for use in texturing a magnetic disk glass substrate and to form a slurry of the composition, alcohol may be added to the composition. In particular, glycols, C3-C10 polyhydric alcohols, dimethyl sulfoxide (DMSO), dimethylformamide (DMF), tetrahydrofuran and dioxane are preferably used. Of these, water and C1-C10 monohydric alcohols are most preferably used.

Though the method of texturing using the composition or slurry for use in texturing will next be described, the present invention is not limited thereto.

Pre-treatment of a magnetic disk glass substrate conducted prior to formation of texture lines is categorized into two types, i.e. formation of an undercoat layer, such as a NiP plating layer, on the magnetic disk glass substrate and formation of no undercoat layer on the substrate. When the undercoat layer has been formed on the substrate, texture lines are formed on the surface of the undercoat layer. The texturing process is almost identical with a texturing process adapted to an aluminum substrate coated with an undercoat layer, such as a NiP plating layer. When no undercoat layer has been formed on the substrate, texture lines are formed on the surface of the magnetic disk glass substrate, and an undercoat layer, such as a NiP plating layer, is formed on the textured substrate. The present invention is particularly more effective in the latter case in which texture lines are formed on the surface of the magnetic disk glass substrate on which no undercoat layer, such as a NiP plating layer, has been formed.

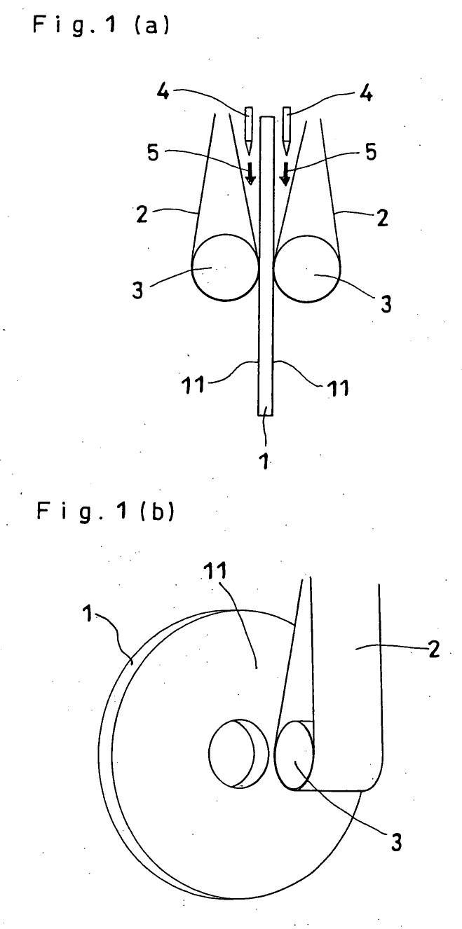

FIG. 1(a) is a schematic front view showing the state in which a magnetic disk glass substrate is subjected to texturing, and FIG. 1(b) is a perspective view showing the state. Each surface 11 of a magnetic disk glass substrate 1 is brought into contact with an object (tape) 2 for sliding contact and pressed against the object (tape) 2 by means of a roller 3. A composition for use in texturing or a slurry 5 of the composition is fed to a sliding contact surface of the tape and/or that of an magnetic disk glass substrate surface, from a slurry-feeding apparatus 4 provided above the tape 2, in a direction of running of the tape 2. The magnetic disk glass substrate 1 is rotated while each tape 2 remains pressed, to thereby form texture lines on each surface of the magnetic disk substrate. In FIG. 1(b), the tape 2 can be moved in a direction that is the same as or opposite that of rotation of the magnetic disk substrate 1, by means of modifying the rotation of the roller 3. In other words, the contact portion on the magnetic disk glass substrate slides in a circumferential direction, resulting in sliding contact with abrasive grains adhering on the tape or another medium, to thereby form texture lines on the substrate surface. The feeding manner of the slurry-feeding apparatus 4 may be continuous, intermittent or discontinuous. No particular limitation is imposed on the method of pressing the tape 2, but the tape may be pressed by the weight of roller itself or may be pressed by means of external pressure.

When the composition or slurry of the present invention for use in texturing is used, the external pressure for pressing the object for sliding contact preferably falls within a range of 0.98 to 196 N (0.1 to 20 kgf), more preferably 4.9 to 98 N (0.5 to 10 kgf), in view of formation of favorable texture lines.

Examples of the material of the object (tape) for sliding contact that can be used in the present invention include woven fabric; non-woven fabric; flocked fabric each made of nylon fiber, polyester fiber, etc.; and polyurethane foam. Of these, woven fabric is preferably used.

In texturing, the magnetic disk substrate 1 is rotated at 50 to 2,000 rpm, preferably 100 to 1,000 rpm. When the rotation speed is slower than 50 rpm, formation of texture lines on the surface of the magnetic disk glass substrate requires a considerably long period of time, whereas when the speed is faster than 2,000 rpm, the composition for use in texturing becomes unable to remain on the surface of the undercoat layer and is dispersed to the outside of the surface, causing contamination of the texturing apparatus, which is not preferable.

On the thus-textured undercoat layer, an intermediate layer and a magnetic layer are formed, to thereby provide a magnetic disk. Since the intermediate layer and magnetic layer are formed to small thickness (generally 0.05 to 0.15 μm) through plating, sputtering, vapor-deposition or other such techniques practiced in the art, lines substantially similar to the texture lines are regenerated on the surface of the magnetic layer. The magnetic layer may be further coated with a protective layer, which is formed to a small thickness (generally 0.01 to 0.03 μm) from a material of high lubricity, such as carbon, through sputtering or a similar method. Thus, the lines substantially similar to the texture lines are also regenerated on the surface of the protective layer.

The present invention will next be described in detail by way of examples, which should not be construed as limiting the invention thereto. In the following Working Examples, diethylene glycol monobutyl ether was used as the alkylene glycol monoalkyl ether, and ethylene glycol was used as the C2-C5 polyhydric alcohol. However, the present invention is not limited to use of these compounds.

### WORKING EXAMPLES 1 TO 6

A mirror-polished glass (chemically strengthened glass) substrate for a magnetic disk having a diameter of 6.4 cm (2.5 inches) was subjected to texturing without being plated with NiP. Texturing was performed using a texturing machine (type EDC-1800A, product of Exclusive Design Inc.) as shown in FIG. 1.

The disk was rotated at 400 rpm, while a slurry formed of each composition shown in Table 1 below for use in texturing a magnetic disk glass substrate was fed from a slurry-feeding apparatus to the upper side of a portion to be polish-processed by means of a tape for sliding contact. The feeding speed was 10 ml/min, and the slurry was fed continuously during texturing.

During texturing, the roller was rotated such that the tape ran at 5 cm/min in the direction identical with the rotation direction of the magnetic disk glass substrate. The pressure of the roller during texturing was 39.2 N (4.0 kgf), and the texturing time was 60 seconds.

After completion of texturing, each magnetic disk glass substrate was evaluated in the following manner.

Evaluation Methods:

(1) Observation of Texture Lines:

By use of an atomic force microscope (Nanoscope-III, product of Digital Instruments Inc.), formation of clear texture lines was identified within an area (1 μm x 1 μm) through visual observation.

(2) Mean Surface Roughness (Ra):

By use of a contact profile meter (Talystep, product of Rank-Taylor Hobson Inc.), the mean surface roughness of each disk glass substrate surface after completion of the process was measured.

Surface roughness was measured in a direction normal to texture lines (radial direction) and in a direction parallel to the texture lines. Measurement in two directions was performed because it is considered to provide a basis for numerical judgment. That is, when clear texture lines are formed, the mean surface roughness measured in the radial direction should be greater than that measured in the circumferential direction.

The obtained evaluation results are shown in Table 1 below.

TABLE 1

| | Microparticles or | | | | | | | | | |
|---|---|---|---|---|---|---|---|---|---|---|
| | powder | | | Fluoride | | Solvent | | Evaluation results | | |
| | | Av. | Amount | | Amount | | Amount | | Ra | |
| | | size | added | | added | | added | Formation | (Å) | |
| | Type | (μm) | (mass %) | Type | (mass %) | Type | (mass %) | of lines | radial | circumferential |
| Ex. 1 | Diamond | 0.2 | 0.1 | NH₄F | 2 | water | 97.9 | yes | 5.8 | 4.3 |
| Ex. 2 | Diamond | 0.2 | 0.1 | NaF | 2 | water | 97.9 | yes | 6.1 | 4.3 |
| Ex. 3 | Diamond | 0.2 | 0.1 | KF | 2 | water | 97.9 | yes | 5.8 | 4.2 |
| Ex. 4 | Diamond | 0.2 | 0.1 | NaF | 2 | BG | 97.9 | yes | 6.2 | 4.3 |
| Ex. 5 | Diamond | 0.2 | 0.1 | NaF | 2 | EG | 97.9 | yes | 5.9 | 4.4 |
| Ex. 6 | SiC | 0.4 | 0.1 | NaF | 2 | water | 97.9 | yes | 7.5 | 4.5 |

| | | | |
|---|---|---|---|
| Substrate mirror-polished before texturing | no | 3.8 | 3.9 |

* BG: diethylene glycol monobutyl ether,
EG: ethylene glycol

### COMPARATIVE EXAMPLES 1 TO 6

The procedure of Working Example 1 was repeated, except that compositions shown in Table 2 below for use in texturing a magnetic disk glass substrate were used, to thereby perform texturing. In a manner similar to that of Working Example 1, magnetic disk glass substrates were evaluated after completion of texturing. The results are shown in Table 2 below.

TABLE 2

| | Microparticles or | | | | | | | | | |
|---|---|---|---|---|---|---|---|---|---|---|
| | powder | | | Fluoride | | Solvent | | Evaluation results | | |
| | | Av. | Amount | | Amount | | Amount | | Ra | |
| | | size | added | | added | | added | Formation | (Å) | |
| | Type | (μm) | (mass %) | Type | (mass %) | Type | (mass %) | of lines | radial | circumferential |
| Comp. | Diamond | 0.2 | 0.1 | none | 0 | water | 99.9 | no | 3.8 | 3.9 |
| Ex. 1 | | | | | | | | | | |
| Comp. | Diamond | 0.2 | 0.1 | none | 0 | water | 99.9 | no | 3.8 | 4.0 |
| Ex. 2 | | | | | | | | | | |
| Comp. | Diamond | 0.2 | 0.1 | none | 0 | water | 99.9 | no | 3.9 | 4.1 |
| Ex. 3 | | | | | | | | | | |
| Comp. | Diamond | 0.2 | 0.1 | none | 0 | BG | 99.9 | no | 3.8 | 3.7 |
| Ex. 4 | | | | | | | | | | |
| Comp. | Diamond | 0.2 | 0.1 | none | 0 | EG | 99.9 | no | 3.7 | 3.9 |
| Ex. 5 | | | | | | | | | | |
| Comp. | SiC | 0.4 | 0.1 | none | 0 | water | 99.9 | no | 4.0 | 3.9 |
| Ex. 6 | | | | | | | | | | |

* BG: diethylene glycol monobutyl ether,
EG: ethylene glycol

The clear texture lines were formed as shown in Table 1 above when the surface of the magnetic disk glass was subjected to texturing using the composition of the present invention for use in texturing that contains a fluoride. In contrast, no texture line was formed as shown in Table 2 above even when the surface of the magnetic disk glass was subjected to texturing using the composition containing no fluoride under the same conditions.

### INDUSTRIAL APPLICABILITY

By use of the composition of the present invention for use in texturing, chemical effect due to fluoride and physical effect due to the microparticles or powder are provided in combination, to thereby form minute texture lines on the surface of a magnetic disk glass substrate of high rigidity and hardness. Accordingly, a magnetic disk glass substrate having a highly regulated surface can be produced. In addition, by use of the magnetic disk substrate, there can be produced magnetic media which exhibit high magnetic anisotropy, high recording density by virtue of reduction of the flying height of a magnetic head and reliability by virtue of preventing occurrence of adhesion of a magnetic head.

1. A composition for use in texturing a magnetic disk glass substrate, which comprises abrasive grains, solvent and a fluoride.

2. The composition according to claim 1, wherein the fluoride is at least one species selected from the group consisting of ammonium fluoride, potassium fluoride and sodium fluoride.

3. The composition according to claim 1 or claim 2, wherein the solvent contains a substance that can dissolve the fluoride.

4. The composition according to claim 3, wherein the substance is water.

5. The composition according to any one of claims 1 to 4, wherein the solvent is at least one species selected from the group consisting of alkylene glycol monoalkyl ethers represented by formula R₁O(CₙH₂ₙO)ₘH (wherein R₁ represents a C1-C4 linear or branched alkyl group, m is an integer of 1, 2 or 3, and n is an integer of 2 or 3), derivatives thereof, C2-C5 polyhydric alcohols and derivatives thereof.

6. The composition according to any one of claims 1 to 5, wherein the abrasive grains are grains of at least one species selected from the group consisting of diamond, CBN, alumina and silicon carbide.

7. The composition according to any one of claims 1 to 6, wherein it contains the fluoride in an amount falling within a range of 0.01 to 10 mass % based on a total amount of the composition.

8. The composition according to any one of claims 1 to 7, wherein it has a fluoride ion concentration falling within a range of 0.003 to 3 mol/kg.

9. The composition according to any one of claims 1 to 8, wherein the abrasive grains have a maximum particle size of 5 μm or less.

10. The composition according to any one of claims 1 to 9, wherein the abrasive grains have an average particle size falling within a range of 0.01 to 1 μm.

11. The composition according to any one of claims 1 to 10, wherein it contains the abrasive grains in an amount falling within a range of 0.001 to 5 mass % based on a total amount of the composition.

12. The composition according to any one of claims 1 to 11, wherein it contains the solvent in an amount falling within a range of 1 to 50 mass % based on a total amount of the composition.

13 A slurry for use in texturing, which comprises the composition according to any one of claims 1 to 12.

14. The slurry according to claim 13, further comprising at least one additional species selected from the group consisting of water, C1-C10 monohydric alcohols, glycols, C3-C10 polyhydric alcohols, dimethyl sulfoxide, dimethylformamide, tetrahydrofuran and dioxane.

15. The slurry according to claim 13 or claim 14, wherein it contains the composition in an amount falling within a range of 10 to 80 mass % based on a total amount of the slurry.

16. A method for producing a magnetic disk glass substrate that has undergone texturing, which comprises pressing a surface of a magnetic disk glass substrate against a surface of an object for sliding contact at a pressure falling within a range of 0.98 to 196 N; feeding the composition according to any one of claims 1 to 12 onto at least one of the surface of the object and the surface of the magnetic disk glass substrate; and rotating the magnetic disk glass substrate while the object remains pressed, to thereby perform texturing of the surface of the magnetic disk glass substrate.

17. A method for producing a magnetic disk glass substrate that has undergone texturing, which comprises pressing a surface of a magnetic disk glass substrate against a surface of an object for sliding contact at a pressure falling within a range of 0.98 to 196 N; feeding the slurry according to any one of claims 13 to 15 onto at least one of the surface of the object and the surface of the magnetic disk glass substrate; and rotating the magnetic disk glass substrate while the object remains pressed, to thereby perform texturing of the surface of the magnetic disk glass substrate.

18. The method according to claim 16 or claim 17, wherein the object is formed of any one of materials selected from the group consisting of woven fabric, non-woven fabric and flocked fabric each made of nylon fiber or polyester fiber, and polyurethane foam.

19. The method according to any one of claims 16 to 18, wherein the magnetic disk glass substrate is rotated at a rate falling within a range of 50 to 2,000 rpm.

20. The method according to any one of claims 16 to 19, wherein the magnetic disk glass substrate has a surface that NiP-plating-free prior to texturing.

21. The method according to any one of claims 16 to 20, wherein the magnetic disk glass substrate is formed of unstrengthened glass, chemically strengthened glass or glass ceramic.

22. A magnetic disk glass substrate that is produced through the method according to any one of claims 16 to 21.

23. A magnetic disk glass substrate that is produced through texturing using the composition according to any one of claims 1 to 12.

24. A magnetic disk glass substrate that is produced through texturing using the slurry according to any one of claims 13 to 15.
